(19) United States
(12) Patent Application Publication
(10) Pub. No.: US 2003/0163409 A1
(43) Pub. Date: Aug. 28, 2003

(54) Systems and methods for establishing auditable records of the process of agreement to a contract

(76) Inventors: Jeremy John Carroll, Livorno (IT); Todd A. Fischer, Boise, ID (US); Shell Sterling Simpson, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/263,152

(22) Filed: Oct. 2, 2002

Related U.S. Application Data
(63) Continuation-in-part of application No. 10/075,544, filed on Feb. 13, 2002.

(51) Int. Cl. G06F 17/60

(52) U.S. Cl. 705/37

(57) ABSTRACT

A network interface configured to monitor communications between an e-customer and an e-vendor coupled to a network; and an auditable record engine, the auditable record engine including an identity discriminator configured to receive the communications and identify the e-customer and the e-vendor; a communication discriminator configured to receive the communications, extract information indicative of a stage of a e-service transaction; and a record formatter configured to generate an independent summary of the communication session. A representative method includes recognizing that a communication session has been established between at least two parties, identifying one of the parties as the source of the communication, extracting information from a message sent from the source to a destination party to form a communication summary, and appending the communication summary in an independent log.

### CROSS-REFERENCE TO RELATED APPLICATION

This application is a continuation-in-part of copending U.S. utility application entitled, “Establishing Auditable Records of the Process of Agreement of Contract by Multiple Participants in a Service,” having Ser. No. 10/075,544, filed Feb. 13, 2002, which is entirely incorporated herein by reference.

### TECHNICAL FIELD

The present invention generally relates to systems and methods for establishing an auditable record of the process of agreement to a contract by multiple participants in a service, particularly an e-service.

### BACKGROUND

An e-service is a service invoked over a computer network, for which there is accounting so that a seller providing a product or service can identify the buyer and achieve payment for the service or product the seller supplies. In an e-service transaction, there is a contract formation phase during which a potential seller negotiates with a potential buyer. After an agreement or contract is reached, the e-service transaction enters an execution phase, where the seller provides the product or service to the buyer. Generally, in an e-service transaction, the e-vendor and the e-customer communicate with each other via network-coupled computing devices.

The buyer may be a consumer of the product or service or an intermediary with whom the seller is contracted to supply the product or service; the seller may be an originator of the product or service, such as a manufacturer of a product, or may be an intermediary with whom the buyer enters a contract for the supply of the product or service. Other complex e-service supply chains are possible involving any number parties to any e-service transaction. An e-customer is a party to the e-service that requires a product or service. An e-vendor is any party with whom the e-customer communicates for the purposes of the transaction. An e-vendor may not be the eventual supplier of the product or service to the e-customer.

During the contract formation phase of the e-service transaction, the parties (i.e., the potential e-vendor and the potential e-customer) may create a job ticket, which details the business processes that need to be completed during the contract execution phase of the e-service transaction. The job ticket may be modified several times during the contract formation phase, until eventually a contract is established.

In the event of a disagreement relating to the e-service transaction, for example, a disagreement concerning how the e-vender is to be paid, the nature of the contract execution, or other matters, problems may arise in establishing what the parties to the e-service transaction agreed to in the final form of the contract. In particular, problems may arise where during the course of contract formation and execution there have been many changes. When the parties have formed an e-service contract, determining what the parties agreed to in the contract can be problematic because the contract is in an electronic format and hence is not an immutable object.

In conventional paper-based business systems, an immutable paper contract document is established after any negotiation, and changes cannot readily be entered subsequent to signing, at least without visibly annotating the original contract document.

Moreover, in a paper-based business system, there may be a record of how the contract assumed the final form, through, for example, a sequence of telephone conversations and exchanges of paper documents, although examining such ad-hoc records may present practical difficulties.

In light of the above, there is a need for systems and methods that improve the process of verifying contract information established in an e-service environment.

### SUMMARY

Systems and methods for establishing an auditable record of the process of agreement to a contract by multiple participants in a service are provided. A representative system includes a network interface configured to monitor communications between an e-customer and an e-vendor coupled to a network; and an auditable record engine, the auditable record engine including an identity discriminator configured to receive the communications and identify the e-customer and the e-vendor; a communication discriminator configured to receive the communications, extract information indicative of a stage of a e-service transaction; and a record formatter configured to generate an independent summary of the communication session.

A representative method includes the following steps: recognizing that a communication session has been established between at least two parties, identifying one of the parties as the source of the communication, extracting information from a message sent from the source to a destination party to form a communication summary, and appending the communication summary in an independent log.

Other systems, methods, and features of the present invention will be or become apparent to one skilled in the art upon examination of the following drawings and detailed description. It is intended that all such additional systems, methods, and features are included within this description, are within the scope of the present invention, and are protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram illustrating an embodiment of an e-service system.

FIG. 2 is a block diagram illustrating an embodiment of the contract manager of FIG. 1.

FIG. 3 is a functional block diagram illustrating an embodiment of the auditable record generator of FIG. 2.

FIG. 4 is a functional block diagram illustrating the generation of a communication summary in the e-service system 10 of FIG. 1.

FIG. 5 is a flow diagram illustrating an embodiment of a representative method for establishing auditable records of the process of agreement of contract that can be implemented by the contract manager of FIG. 1.

### DETAILED DESCRIPTION

The present invention provides systems and methods of establishing an auditable record of the process of agreement to a contract by multiple participants in an e-service transaction over a computer network. In an e-service transaction, an e-customer and an e-vendor negotiate during a contract formation phase or during a contract execution phase of the e-service. A product or service is supplied and/or provided to the e-customer during a contract execution phase of the e-service. One method in accordance with the invention includes providing a contract manager which monitors communications between the parties relating at least to the contract formation phase of the e-service transaction. The contract manager generates an auditable record of the negotiation to maintain an independent record of the negotiations that led to the contract.

Thus, in the event of a dispute arising between the parties, for example, a conflict regarding a provision of the contract, the parties may consult the contract manager to accurately verify the relevant contract provision. Because the contract manager stores an independent record of communications between the parties to a contract, the contract manager may be consulted by one or both of the parties to the contract to assist in resolving the dispute.

Preferably, the contract manager maintains an auditable record of each step in the negotiations (i.e., contract formation stage). More specifically, a communication summary is recorded when a new contract term is proposed, a change to a contract term is proposed, or a contract term is agreed upon, so that the party to the negotiation who made an initial proposal or proposed a modification to a previously proposed contract term, may subsequently be identified. A communication summary may include a source party identifier, a destination party identifier, communication content, and a timestamp.

Preferably the contract manager is operated independently of the e-customer and the e-vendor. In this manner, the contract manager may remain neutral and not under the control of either party.

The parties may negotiate using a job ticket format, such as the Adobe/Heidleberg job ticket format, where the contract relates to a printing service, with the job ticket being exchanged between the e-vendor and e-buyer during the contract formation phase of the transaction. During contract formation, the proposed parties make proposals and counter proposals for the contract terms. However, because the contract manager is keeping a record of each step in the negotiation, it is not essential for the parties to exchange the entire job ticket to make a fresh proposal or to propose a modification to a contract term. Some embodiments enable the parties to exchange a reference only to the contract being negotiated, along with any fresh proposal or proposal of a modification to any contract term.

Preferably, the contract manager, in addition to monitoring communications and recording an auditable record of the communications between the parties during the contract formation phase of the e-service transaction, further monitors communications between the parties during the execution phase of the e-service transaction and adds communication summaries to the previously established auditable record. In this way, the contract manager generates and stores an auditable record of communications between the parties to the e-service contract during the execution phase of the contract. The auditable record maintains an independent record of such communications between the e-vendor and the e-customer.

Thus, for example, in the event that the parties agree to a change in the negotiated contract during the contract execution phase of the e-service transaction, a record of such change will be maintained, preferably along with an auditable record of which party proposed and which party agreed to, the change. Moreover in the event of a dispute concerning any breach of the agreed-to contract terms, the contract manager, will serve as a well-suited resource for establishing the historical record of contract communications between the parties.

Typically, the parties to the e-service transaction will each be connected to a network. The network may be a local area network (LAN), a wide area network (WAN), for example, the Internet, an Intranet, or a Virtual Private Network (VPN). The contract manager is preferably connected to the network to enable the contract manager to monitor communications between the parties. The contract manager may be enabled by one or both parties, or upon the agreement of both parties. Regardless, of the source of enablement, it is preferred that the contract manager is enabled before the parties agree to contract terms.

The systems and methods for establishing an auditable record of the process of agreement to a contract by multiple participants in an e-service, during a contract execution phase of an e-service transaction, provides a contract manager which monitors communications between the parties relating at least to the contract execution phase of the e-service transaction. The contract manager may be configured to add to a previously generated auditable record of communications between the parties to the contract to generate an independent record of the modified contract. Alternatively, the contract manager may be configured to generate a separate auditable record of contract modifications negotiated during the execution stage of the e-service transaction. The contract manager may have any of the features of the contract manager configured to generate an auditable record during the formation stage of the e-service transaction.

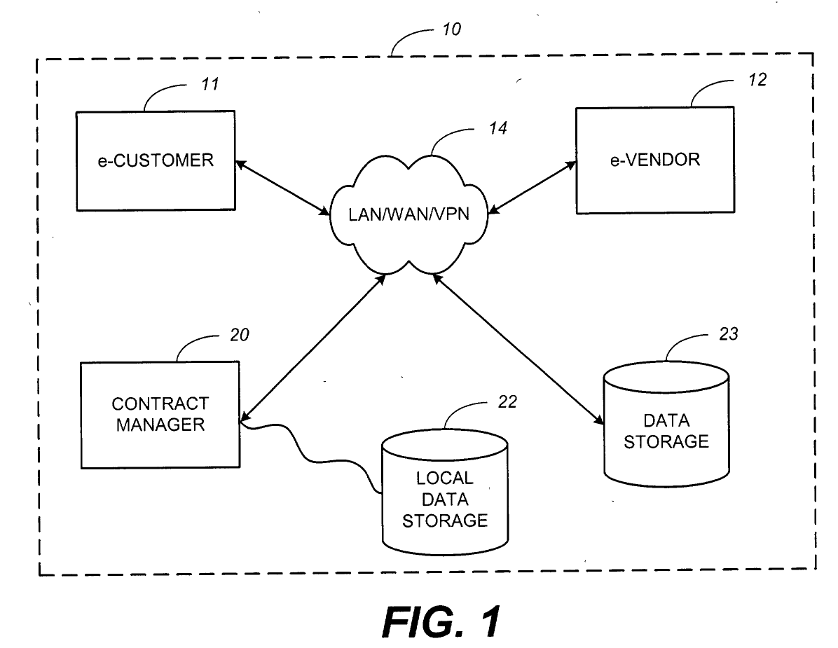

Referring now in more detail to the drawings, in which like numerals indicate corresponding parts throughout the several views, FIG. 1 illustrates an embodiment of an e-service system 10. As indicated, the system 10 includes an e-customer 11 and an e-vendor 12 communicatively coupled via network 14. As suggested by FIG. 1, the e-customer 11 and the e-vendor 12 may be coupled by a local area network (LAN), a wide area network (WAN), or a virtual private network (VPN). Regardless of the particular network 14 used to couple the e-customer 11 to the e-vendor 12, during an e-service transaction (not shown), the e-customer 11 and the e-vendor 12 negotiate to establish the parties, subject matter, price, and/or performance (i.e., the terms) of a e-service contract or agreement.

It will be understood that the e-customer 11 and the e-vendor 12 may be communicatively coupled by a respective computing device(s) and/or suitably configured communication devices. The computing devices, not shown for simplicity of illustration, can be workstations, personal computers (PCs) such as desktop computers, laptop computers, and the like, personal data assistants (PDAs) and/or other remote communication devices such as cellular telephones, among others.

In accordance with a preferred embodiment, a contract manager 20 is integrated to the network 14. The contract manager 20 may be enabled by either or both the e-customer 11 and the e-vendor 12 at any time during the formation or execution stages of an e-service transaction or contract. It will be understood that when the contract manager 20 is enabled after some portion of the formation or life cycle of the e-service contract, the contract manager 20 will provide a record of the communications between the parties from that time forward for as long as the contract manager is enabled.

As illustrated in FIG. 1, the contract manager 20 may be integrated with a local data storage device 22 for retaining a historical log of the related communications to each specific e-service transaction contemplated between the e-customer 11 and the e-vendor 12. Alternatively, and/or as a safety measure, the contract manager may be configured to store a copy of the related communications in remote data storage 23.

An e-service transaction has at least two phases. During a first, or formation phase of the e-service transaction, the two parties 11, 12 negotiate to establish a contract for the supply of goods or services from the e-vendor 12 to the e-customer 11. In a second, or execution phase of the e-service transaction, the e-vendor 12 supplies the goods or services to the e-customer 11. Note that the e-vendor 12 could be an intermediary, such as a broker, such that the goods or services are supplied by the third-party intermediary or broker after the terms of the contract between the e-vendor 12 and e-customer 11 have been established.

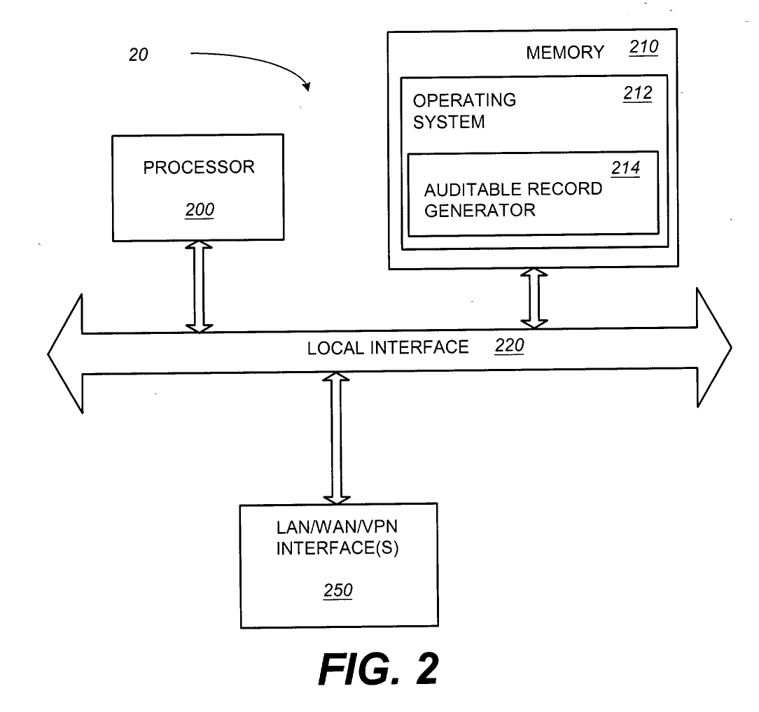

FIG. 2 presents a functional block diagram illustrating an embodiment of the contract manager 20 of the e-service 10 of FIG. 1. The contract manager 20 includes a processor 200, memory 210, and LAN/WAN/VPN interface(s) 250 that communicate with each other via a local interface 220. The local interface 220 can be, but is not limited to, one or more buses or other wired or wireless connections as is known in the art. The local interface 220 may include additional elements, such as buffers (caches), drivers, and controllers (omitted here for simplicity), to enable communications. Further, the local interface 220 includes address, control, and data connections to enable appropriate communications among the aforementioned components.

The processor 200 is a hardware device for executing software stored in memory 210. The processor 200 can be any custom made or commercially available processor, a central processing unit (CPU) or an auxiliary processor associated with the contract manager 20, or a semiconductor based microprocessor (in the form of a microchip) or a macroprocessor. Examples of suitable commercially available microprocessors are as follows: a precision architecture reduced instruction set computing (PA-RISC) series microprocessor from the Hewlett-Packard Company, an 80×86 or Pentium series microprocessor from Intel Corporation, a PowerPC microprocessor from IBM, a Sparc microprocessor from Sun Microsystems, Inc, or a 68xxx series microprocessor from Motorola Corporation, among others.

Local interface 220 communicates with input/output devices that connect the contract manager 20 to the network 14 (FIG. 1). These two-way communication devices include, but are not limited to, modulators/demodulators (modems), network interface cards (NICs), radio frequency (RF) or other transceivers, telephonic interfaces, bridges, and routers. For simplicity of illustration, such two-way communication devices are represented by LAN/WAN/VPN interface(s) 250.

The memory 210 can include any one or a combination of volatile memory elements (e.g., random-access memory (RAM, such as dynamic RAM or DRAM, static RAM or SRAM, etc.)) and nonvolatile-memory elements (e.g., read-only memory (ROM), hard drive, tape drive, compact disc (CD-ROM), etc.). Moreover, the memory 210 may incorporate electronic, magnetic, optical, and/or other types of storage media. Note that the memory 210 can have a distributed architecture, where various components are situated remote from one another, such as on the network 14 that are accessible via firmware and/or software operable on the processor 200.

The software in memory 210 may include one or more separate programs and data files. For example, the memory 210 may include an auditable record generator 214. Each of the one or more separate programs will comprise an ordered listing of executable instructions for implementing logical functions. Furthermore, the software in the memory 210 may include a suitable operating system 212. A non-exhaustive list of examples of suitable commercially available operating systems 212 is as follows: a Windows operating system from Microsoft Corporation, a Netware operating system available from Novell, Inc., a UNIX operating system, which is available for purchase from many vendors, such as Hewlett-Packard Company and Sun Microsystems, Inc., or a LINUX operating system, which is available from Red Hat, Inc., among others.

The operating system 212 essentially controls the execution of other computer programs, such as the auditable record generator 214 and other programs that may be executed by the contract manager 20 of the e-service system 10. Moreover, more than one operating system may be used by the contract manager 20 associated with the e-service system 10. An appropriately configured contract manager 20 may be capable of executing programs under multiple operating systems 212. The operating system 212 provides scheduling, input-output control, file and data management, memory management, and communication control and related services.

It should be understood that the auditable record generator 214 can be implemented in software, firmware, hardware, or a combination thereof. The auditable record generator 214, in the present example, can be a source program, executable program (object code), or any other entity comprising a set of instructions to be performed. When in the form of a source program, the auditable record generator 214 is translated via a compiler, assembler, interpreter, or the like, which may or may not be included within the memory 210, to operate in connection with the operating system 212. Furthermore, the auditable record generator 214 can be written as (a) an object-oriented programming language, which has classes of data and methods, or (b) a procedure-programming language, which has routines, subroutines, and/or functions, for example but not limited to, C, C++, C Sharp, Pascal, Basic, Fortran, Cobol, PERL, Java, and Ada, among others.

When the contract manager 20 is in operation, the processor 200 executes software stored in memory 210, communicates data to and from memory 210, and generally controls operations of the coupled LAN/WAN/VPN interface(s) 250 pursuant to the software. The auditable record generator 214, the operating system 212, and any other applications are read in whole or in part by the processor 200, buffered by the processor 200, and executed.

When the auditable record generator 214 is implemented in software, as shown in FIG. 2, it should be noted that the logic contained within the auditable record generator 214 can be stored on any computer-readable medium for use by or in connection with any computer-related system or method. In the context of this document, a computer-readable medium is an electronic, magnetic, optical, or other physical device or means that can contain or store a computer program for use by, or in connection with a computer-related system or method. The computer-readable medium can be, for example but not limited to, an electronic, magnetic, optical, electromagnetic, infrared, or semiconductor system, apparatus, device, or propagation medium.

Contract Manager Architecture and Operation

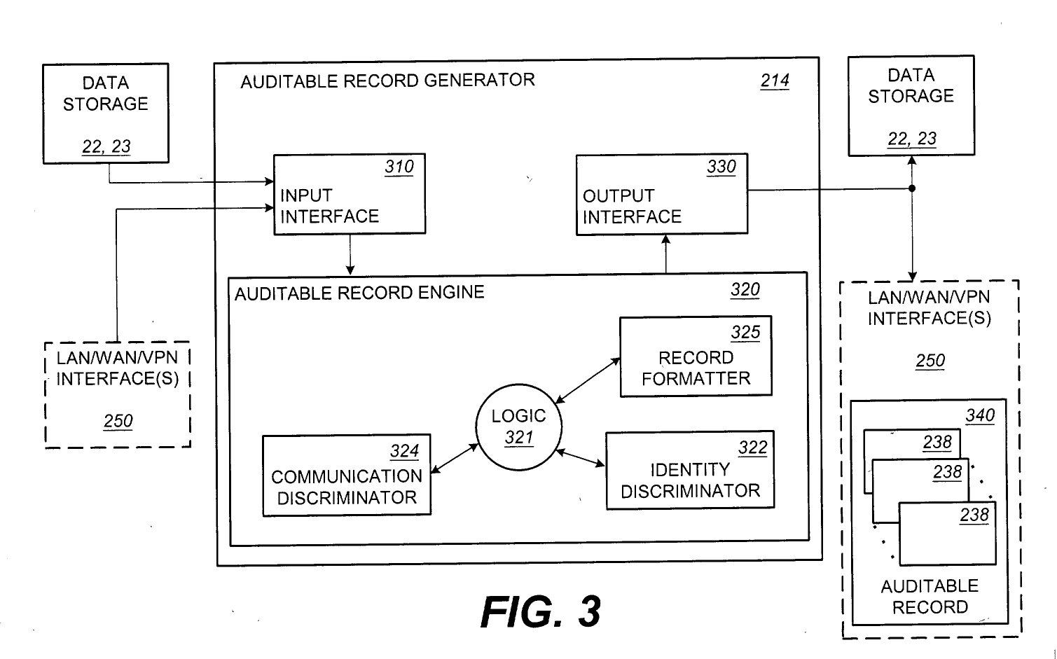

Reference is now directed to the functional-block diagram of FIG. 3, which illustrates an embodiment of the auditable record generator 214 of FIG. 2. The auditable record generator 214 includes an input interface 310, an auditable record engine 320, and an output interface 330. The auditable record generator 214 interacts with memory 210 or other distributed memory devices associated with the network 14 such as remote data storage device 23 under the direction of the contract manager 20. In addition, the auditable record generator 214 is communicatively coupled to the network 14 via LAN/WANNVPN interface(s) 250 to enable monitoring of network processed communications between the e-vendor 12 and the e-customer 11. It will be understood by those having ordinary skill in the art that the implementation details of the auditable record generator 214, as well as any communications records or files generated by the auditable record generator 214 and stored within the memory 210 will differ based on the underlying technology used in implementing the network 14 and the individual communications between the e-customer 11 and the e-vendor 12 in the e-service system 10.

As illustrated in FIG. 3, the auditable record engine 320 is in communication with the input interface 310 and the output interface 330. The input interface 310 is configured to receive communications via LAN/WANNVPN interface(s) 250 and/or previously generated records from either a local data storage device 22 or a remote data storage device 23 coupled to the network 14 (FIG. 1).

The auditable record engine 320 includes a number of functional modules such as the identity discriminator 322, the communication discriminator 324, and the record formatter 325 each under the control of logic 321. Together the logic 321 and the various functional modules receive, interpret, and log the various communications between the e-customer 11 and the e-vendor 12 in the e-service system 10. Logic 321 coordinates the flow of information from the input interface 310 and to the output interface 330. Logic 321, as described above, can be enabled by either or both parties 11, 12. Logic 321 identifies a proposed e-service transaction and manages the creation and storage of an independent auditable record 340 of the communications between the parties related to the proposed e-service transaction. Once the parties 11, 12 have formulated an e-service agreement or contract, the logic 321 may update the record accordingly. In preferred embodiments, the contract manager 20 appends the auditable record 340 created during the formation stage with any communications between the parties 11, 12 during the execution stage of the e-service transaction.

Logic 321 may identify the parties 11, 12 in any of a number of ways. For example, the parties 11, 12 may be identified by their respective corporate name, user name, network node, login id, communication device identifier, among others. Each contemplated e-service transaction between the parties 11, 12 is assigned a unique e-service transaction identifier. The, e-service transaction identifier can be assigned by logic 321 or alternatively by the initiating party. The e-service transaction identifier can be forwarded to the non-initiating party and used by both parties 11, 12 to associate related communications. Logic 321 also coordinates the operation of the identity discriminator 322, the communication discriminator 324, and the record formatter 325.

The identity discriminator 322 identifies the source and the destination of each of the various communications to be processed by the contract manager 20. For, example, when the e-vendor 12 and the e-customer 11 are negotiating terms of a print job, the e-customer 11 may send an offer to the e-vendor 12 offering to pay $0.XY/sheet for N copies of a poster. In this particular example, the e-customer 11 is the source and the e-vendor 12 is the destination.

The communication discriminator 324 extracts pertinent content from each of the various communications to be processed by the contract manager 20. In the example above, the communication discriminator 324 may identify the content as an offer for N copies of the poster at $0.XY/sheet. Note that the communication discriminator 324 contains logic suitable for extracting and identifying the type and message content of other communications between the parties including acceptances, counter-offers, etc.

The record formatter 325 receives the source and destination from the identity discriminator 322, as well as, communication content from the communication discriminator 324. The record formatter 325 formats the information from the identity discriminator 322 and the communication discriminator 324 and adds a timestamp to the formatted information before storing a communication summary 328. An auditable record 340 includes one or more communication summaries 328. It should be understood that the timestamp will include information indicative of when the communication was processed by the sending and receiving parties, respectively.

As further illustrated in FIG. 3, the auditable record engine 320 forwards the one or more communication summaries 328 forming the auditable record 340 to one or more of the local data storage device 22, the remote data storage device 23, or the LAN/WAN/VPN interface(s) 250 for ultimate communication via the network 14 to the e-customer 11 and the e-vendor 12. Preferably, the auditable record generator 214 of the contract manager 20 is configured to receive, interpret, and record each communication between the parties II, 12 to the e-service contract in real time. Although the contract manager 20 can operate in the background (i.e., receive, interpret, and record each communication without presenting an indication that it is functioning to either of the parties), the contract manager 20 may prove useful when one or more parties 11, 12 to the e-service contract understand that the contract manager 20 is building the auditable record 340.

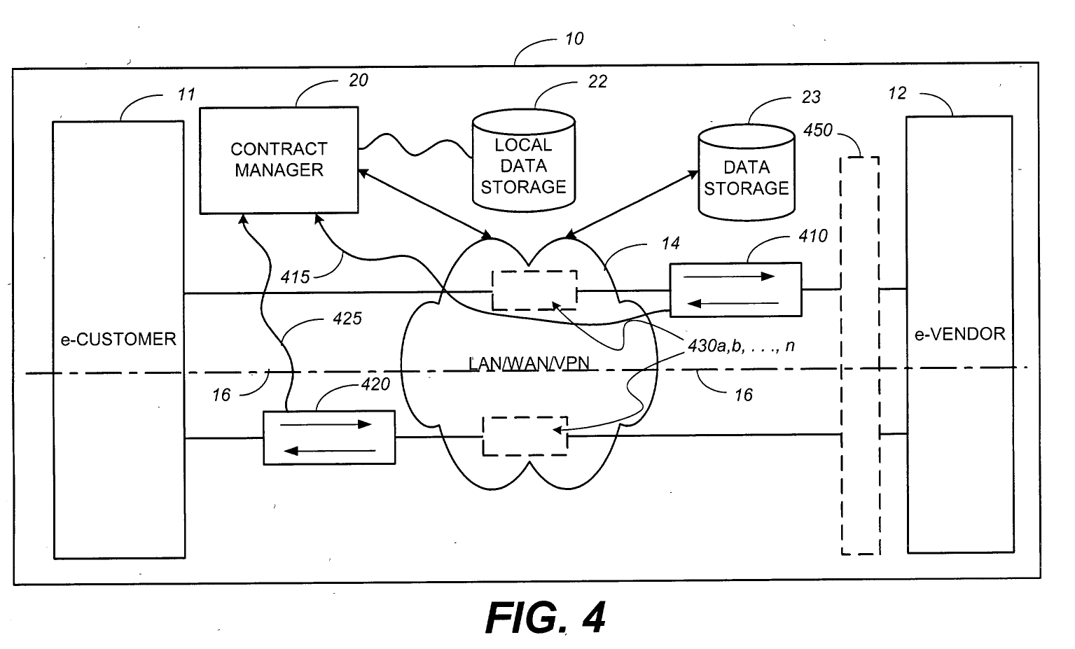

FIG. 4 is a functional block diagram further illustrating the generation of a communication summary 328 in the e-service system 10 of FIG. 1. In the drawing, schematically the two phases of the e-service transaction are shown to be separate phases indicated by line 16. Communications between the e-vendor 12 and e-customer 11 during the contract formation phase of the e-service transaction are indicated by formation communication 410 and exchanges of communications between the e-vendor 12 and e-customer 11 during the contract execution phase of the e-service transaction are indicated by the execution communication 420. As illustrated in FIG. 4, both formation communications 410 and execution communications 420 may originate with either of the parties 11, 12.

Two examples of typical e-service transactions will now be described. In a first example, an e-service transaction relates to a hard-copy product produced by a printing service. In a second example, an e-service transaction relates to the sale of an automobile.

In the first example, the e-customer 11 requires a printing job to be performed by the e-vendor 12 in which a specified number of copies of a multiple color document of X pages are required to be printed and delivered to the e-customer within 3 days. The e-customer 11 would prefer to pay less than $M, but would compromise on price to achieve receipt of the completed print job within the desired time.

Accordingly, the e-customer 11 completes a job ticket or another communication mechanism, e.g., a job ticket inspired by the Adobe/Heidleberg job ticket format, to identify the parameters of the print job and to communicate the e-customer's preferences.

In addition to the information given by way of example above, the job ticket may include preferences such as the quality of paper to be used for the job (e.g., 80 gram woven white paper), whether double-sided printing is desired, the method of binding the pages, etc. Upon completion, the e-customer 11 sends the communication, in this case, a job ticket with these initial proposals for the print job, to the e-vendor 12.

Typically, the e-vendor 12 will propose a change to one or more of these initial proposals (i.e., a counter-offer) and/or make a new proposal. For example, the e-vendor 12 may propose an alternative higher price $Z for the job and may propose to use a specific manufacturer's paper. The job ticket with this counter-offer or new proposal (to use a particular manufacturer's product and the alternative price) together with the unaltered terms of the e-customer's original proposal is returned to the e-customer 11 for consideration.

It will be appreciated that in a e-service system 10, the e-vendor 12 may respond to the e-customer's initial proposal automatically such that human intervention at the e-vendor 12 end of the e-service transaction may not be required. Alternatively, consideration of e-service transaction terms related to the proposed print job parameter by the e-customer 11 may require human intervention.

If the alternative price proposed by the e-vendor 12 and the fresh proposal to use a particular manufacturer's paper for the print job are acceptable to the e-customer 11, the e-service transaction contract may be settled with the e-customer 11 placing an order. However the e-customer 11 may propose alternative parameters, for example to maintain the price below $Y, such as for example for the e-vendor 12 to use a lower quality of paper, or a different binding, etc. for the print job. Accordingly, the e-customer 11 may return the modified terms via a communication or job ticket in the form of formation communication 410 to the e-vendor 12 for further consideration. The negotiations may continue until the print job terms are agreed to by the parties 11, 12 as may be indicated by the e-customer 11 placing, and the e-vendor confirming the print job order.

Because the formation communications 410 (i.e., the exchanges of communications during the contract formation phase of the transaction) are in an electronic format and communicated over the network 14, the agreed contract is not immutable. Accordingly, in the event of a dispute arising between the e-customer 11 and e-vendor 12, there may be difficulties establishing exactly what was agreed between the parties. Of course, each party 11, 12 may keep its own records relating to the negotiation, but there could be circumstances where such records do not agree.

A number of problems may arise during execution of the e-service transaction that may prove difficult for the parties 11, 12 to resolve were each to retain there own set of records concerning the formation stage. For example, the e-customer 11 may receive the completed print job on paper having a lower quality than what the e-customer 11 believes that the parties 11, 12 negotiated; or the print job may be delivered later than the 3 days required by the e-customer 11; or the e-vendor 12 may not receive payment for the print job within a time frame the e-vendor 12 believes is stipulated in the e-service transaction stipulated by the parties 11, 12 during the contract formation phase of the e-service transaction. Because the final order is not immutable, each of the parties 11, 12 is unlikely to respond to demands from the other party supported by the demanding parties' documentation concerning the e-service transaction.

In accordance with the invention, the e-service system 10 includes a contract manager 20 which is preferably independent of the e-customer 11 and e-vendor 12 and is connected to the network 14. The contract manager 20 is configured to monitor the negotiations (i.e., communications) between the parties 11, 12 to the e-service transaction during the contract formation phase of the e-service transaction to provide a mechanism for independent verification and ultimately dispute resolution in the event of a dispute arising between the e-customer 11 and e-vendor 12.

Each formation communication 410 between the e-customer 11 and e-vendor 12 during the contract formation phase of the e-service transaction may result in a “write” call 415 to the contract manager 20, which interprets and records such communications in a communication summary 238 that can be forwarded to the parties 11, 12 and stored in local data storage 22 and/or remote data storage 23. One or more communication summaries 238 each containing the identities of the sending party, the destination party, and the nature of the communication, and terms related to a common e-service transaction for the auditable record 340.

As described above, the contract manager 20 may be invoked at the request of either of the parties 11, 12. For example, by the first communication from the e-customer 11 to the e-vendor 12, or by the first communication from the e-vendor 12 to the e-customer 11. Each of these communications 410 may include a service request to the contract manager 20. The service request includes a reference to an e-service transaction identifier to enable the contract manager 20 to identify communications relating to the e-service transaction of interest on the network 14.

Whereas, in a conventional e-service where a job ticket or other message may be exchanged between the parties at each step in the negotiations, it will be appreciated that by employing the contract manager 20 which establishes an auditable record 340 of the various communications to a contract by multiple participants in an e-service, it is unnecessary for the job ticket to be exchanged. Rather, communications between the parties 11, 12 may include changes to existing proposed contract terms, counter proposals, or fresh proposals, provided that each communication includes the reference to the e-service transaction.

In the event that a dispute arises as to the contract terms, the contract manager 20 may be consulted to ascertain definitively what terms were agreed to by the parties 11, 12. In addition, the auditable record 340 generated and stored by the contract manager 20 can be used to determine which party 11, 12 proposed each of the contract terms and at which stage (and step) the other party agreed to each contract term.

For example, the contract manager 20 may be used to determine that the parties 11, 12 agreed that a particular quality of paper would be used whereas the e-vendor 12 had supplied a lower quality of paper; or the contract manager 20 may be consulted to determine that the e-customer 11 agreed to an alternative delivery schedule of 4 days, not 3; or the contract manager 20 may be consulted to establish the agreed-to time frame for paying the e-vendor 12 for the print job.

It is common in e-service transactions for changes to be made subsequent to the contract being formed and settled, i.e., during the contract execution phase of the e-service transaction. In the example, the e-customer 11 may decide that the print job is required to be delivered more urgently than originally indicated, e.g., within 2 days, or for the print job to be delivered to a different address than that previously included in communications between the parties 11, 12.

Such changes do not usually require a complete re-negotiation of the contract, but do result in a change in the print job parameters. When such changes are deemed by one of the parties to the agreement to be substantial, the contract may be re-negotiated. These modifications during the execution phase of the e-service transaction could result in a dispute during or after the execution of the e-service transaction. For example, the e-vendor 12 may deliver the print job to the originally agreed upon destination address rather than the modified delivery address. Consequently, the e-customer 11 will likely be dissatisfied with the performance of the e-vendor 12 and a dispute may arise as to the identity of the agreed upon delivery address.

To address potential disputes arising from activities of the parties 11, 12 during the execution stage of the e-service transaction, the contract manager 20 may be configured to not only monitor communications between the e-customer 11 and e-vendor 12 during the contract formation phase of the e-service transaction, but also execution communications 420 between the parties 11, 12 during the contract execution phase. Again, each execution communication 420 between the e-customer 11 and e-vendor 12 during the contract execution phase of the e-service transaction may result in a “write” call 425 to the contract manager 20. The contract manager 20 is configured to monitor the negotiations (i.e., communications) between the parties 11, 12 to the e-service transaction during the contract execution phase of the e-service transaction to provide a mechanism for independent verification and ultimately dispute resolution in the event of a dispute arising between the e-customer 11 and e-vendor 12. Preferably, the contract manager 20 associates communication summaries 238 forming the auditable record 340 from both the formation and execution stages of the e-service transaction.

For example, if subsequent to the contract formation phase, the e-customer 11 requests that the print job is delivered to an alternative delivery address, to which change the e-vendor 12 agrees, this exchange of execution communications 420 may be monitored and recorded by the contract manager 20, which generates an independent auditable record 340 of the change. Consequently, the contract manager 20 may be consulted in the event that a dispute arises between the parties 11, 12 at either stage in the life of the e-service transaction.

In a second example, an e-service system 10 is used for the supply of goods, namely a vehicle. An initial communication (i.e., a formation communication 410) from the e-customer 11 may take the form an inquiry such as “I am looking for a <make><model><color>. Do you have one available?” In response to such an inquiry, the e-vendor 12 may begin a transaction negotiation which may be automated by logic suited to process formation communications 410.

For example, the e-vendor 12 may send to the e-customer 11, details of a plurality of alternative vehicles which are available. The formation communication 410, could be in the form of an order template (or templates) including a set parameters that may be used by an e-customer 11 to more specifically define a desired vehicle. Preferably, the e-vendor 12, from the e-customer's 11 initial inquiry selects from all vehicles which the e-vendor 12 is able to supply, a set of vehicles which most closely match the criteria set out by the e-customer 11. For example, vehicles can be classified according to select criteria, such as engine size or body style (sedan, coupe, convertible), etc.

The e-customer 11 may peruse the set of order templates returned by the e-vendor 12 and if the e-customer 11 is interested in buying any of the vehicles, the e-customer 11 may then make an offer, or a counter offer. For example, the order template for a vehicle in which the e-customer 11 is interested, may include a price set by the e-vendor 12. The e-customer 11 may offer a lower price, which may or may not be acceptable to the e-vendor 12. Alternatively, the job ticket may not include an indication of price, but may invite offers, so that the e-vendor 12 may compare alternative offers and accept the highest offer. Regardless of the details encompassed by the formation communications 410, when each of the terms of the sale of the vehicle have been agreed to by the e-customer 11 and the e-vendor 12 an e-service agreement or contract is formed.

If desired, the e-vendor 12 may offer to the e-customer 11 an additional service, such as a vehicle warranty, and negotiations may continue in respect of the additional service under a different e-service transaction identifier, until the secondary e-service transaction is confirmed by the parties 11, 12. Preferably, the contract manager 20 associates the e-service transaction identifiers for the vehicle sale and the secondary sale and purchase of the vehicle warranty.

In accordance with the invention, during all such negotiations between the parties, the contract manager 20 may monitor the negotiation, by logging the initial proposal, and any modification to any proposed contract terms, or any new proposal made during the course of the negotiations, and may keep, e.g., in local data storage device 22, an auditable record 340 of the negotiations, so that the contract manager 20 may be consulted in the event of any dispute arising between the parties 11, 12.

Moreover, in the event of execution communications 420 between the parties 11, 12 during the contract execution phase of the e-service transaction, such communications may be monitored by the contract manager 20 and appended to the auditable record 340. Alternatively, execution communications 420 may be monitored and the resulting communication summaries 238 stored to a new auditable record 340 reflective of the execution phase of the e-service transaction. When it is the case that separate auditable records 340 are generated, preferably the contract manager 20 associates auditable records that share common subject matter (e.g., the e-service transaction for the vehicle sale and the e-service transaction for the related warranty sale).

The contract manager 20 may be enabled to monitor communications relating to the e-service transaction when the job template is sent from the e-vendor 12 to the e-customer 11, and the job template and each job ticket thereof, may include a reference by which the e-service transaction may thereafter be identified.

The contract manager 20 may be enabled to protect the either of the e-vendor 12 or the e-customer 11 from misconstructions of the contract terms by the other party. The contract manager 20 may also preempt deliberate alterations of records relating to the contract terms. While the contract manager 20 is preferably operated independently as described above, the contract manager 20 may be part of, or related to the operations of either the e-vendor 12 or the e-customer 11. When the contract manager 20 is associated with either of the parties 11, 12, the contract manager 20 remains independent of the underlying communications 410, 420 in that the contract manager 20 makes no contribution to the negotiation or execution of the e-service transaction.

When the contract manager 20 is associated with one of the parties 11, 12, the contract manager 20 may be configured to periodically forward a rendition of a communication summary 238 to the party that is not associated with the contract manager 20. These periodic communication summaries 238 can be reviewed and/or confirmed by the receiving party to build confidence in the auditing process and the business practices of the party associated with the contract manager 20. In addition to forwarding the communication summaries, the contract manager 20 preferably continues to generate and store an independent, accurate, and auditable record 340.

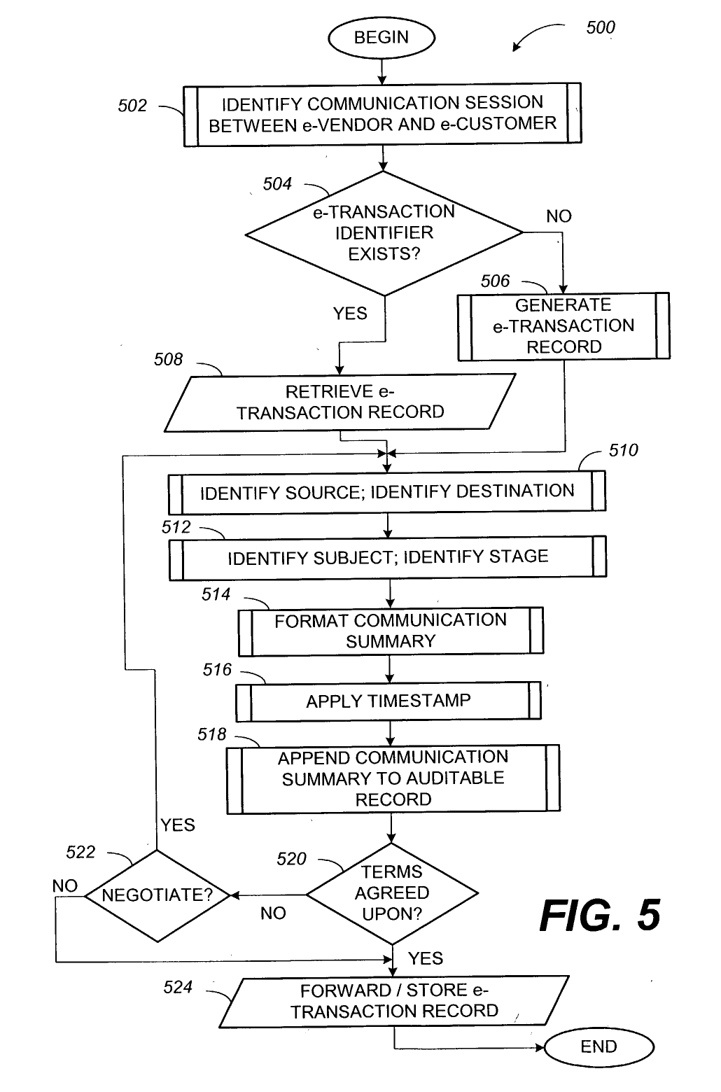

Reference is now directed to FIG. 5 which illustrates a representative method 500 for establishing an auditable record of the process of agreement to a contract by multiple participants in an e-service. In this regard, a suitably configured contract manager 20 may begin with step 502 by identifying a communication session between an e-vendor 12 and an e-customer 11. Next, in step 504, the contract manager 20 determines if an e-transaction identifier exists for the parties identified in step 502. Note that this determination will preferably include a verification that the subject matter matches between message content in the present communication session and the subject matter associated with the e-transaction identifier. When the result of the determination of step 504 is affirmative, the contract manager 20 retrieves the matching e-transaction record. Otherwise, when the result of the query of step 504 indicates that no prior e-transaction record exists, the contract manager 20 generates a new e-transaction record as indicated in step 506.

Next, the contract manager 20 identifies the parties to the communication, the subject matter, and the stage of the e-service transaction (i.e., formation or execution) as indicated in steps 510 and 512. It should be understood that the contract manager 20 may identify the parties, subject matter, and the e-transaction stage in any order desired. It should be further understood that the contract manager may identify the subject matter by various methods including searching textual data included in the message, information inserted in a message header, or by other methodologies. Once, the contract manager 20 has identified the parties, the subject matter, and the stage of the e-service transaction, the contract manager 20 formats a communication summary containing the identified information as indicated in step 514.

Next, in step 516, the contract manager 20 applies a timestamp to the formatted communication summary. As illustrated in step 518, the contract manager 20 appends the communication summary to the auditable e-transaction record. As described above, the contract manager 20, in some alternative embodiments, may be configured to forward the communication summary to one or both of the e-vendor 12 and the e-customer 11.

As indicated in the query of step 520, the contract manager 20 determines whether the proposed and communicated terms have been agreed to by both parties 11, 12. If the result of the query of step 520 is negative, the contract manager 20 further queries the parties 11, 12 in step 522 whether it is desired to keep the communication session open, thereby extending a period for negotiating between the parties 11, 12 related to the subject matter. Thereafter, the contract manager 20 repeats steps 510 through 522 as may be desired. As indicated by the flow control arrows exiting the queries of steps 520 and 522, when the terms have been agreed on or when the negotiation period is terminated, the contract manager 20 forwards and/or stores the appended e-transaction record (i.e., the auditable record 340) as indicated in step 524. Thereafter, the contract manager 20 may terminate the method 500.

Any process descriptions or blocks in the flow diagram of FIG. 5 should be understood as representing modules, segments, or portions of code which include one or more executable instructions for implementing specific logical functions or steps in the process for presenting a representation of a source object. Alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

Various modifications may be made without departing from the scope of the invention. In the two examples described above, the initial communication relating to the e-service transaction originated from the e-customer 11. The contract manager 20 is not limited to receiving communications 410, 420 from one party. The contract manager 20 may receive a communication 410, 420 that originates with the e-vendor 12. For example, the e-vendor 12 may broadcast an advertisement to a plurality of potential e-customers 11 connected to the network 14, concerning the availability of a particular product or service. While the contract manager 20 could be enabled by the e-vendor 12 to monitor all-communications relating to such a broadcast (i.e., generating a monitoring session for subsequent communications between the e-vendor and each destination party designated to receive the advertisement), preferably the contract manager 20 is enabled once a specific e-service transaction negotiation commences. For example, when a potential e-customer 11 responds to the advertisement. In this preferred embodiment, the contract manager 20 may be configured to retrieve a copy of a communication summary 238 that details the broadcast communication.

The e-service system 10 indicated in the drawing is a very simple e-supply chain. However, the contract manager 20 may be applied to more complex supply chains in which there are one or more proxies 450 between the e-customer 11 and the e-vendor 12. Alternatively, the contract manager 20 can be applied to a supply e-service system 10 in which there are a plurality of alternative e-vendors 12 with which the e-customer 11 competitively negotiates before placing an order. In this case, the contract manager 20, or a plurality of contract managers 20, may monitor some or all of the negotiations, to provide auditable records 340 of such negotiations.

Formation and/or execution communications 410, 420 exchanged during performance of the method of the invention may use cryptographic technology for any and all portions of the individual communications as may be desired. Moreover, communication summaries 238 may also be encrypted prior to being stored and/or transmitted to either of the parties 11, 12 via the network 14.

The detailed description has been presented for purposes of illustration and description of specific embodiments of the invention. It is not intended to be exhaustive or to limit the invention to the precise forms disclosed. Modifications or variations are possible in light of the above teachings. The embodiment or embodiments discussed, however, were chosen and described to provide the best illustration of the principles of the invention and its practical application to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

Therefore, having thus described the invention, at least the following is claimed:

1. A method of establishing an auditable record of communications over a network, the method comprising:
recognizing that a communication session has been established between at least two parties, the communication session being operable over a network;
identifying a first of the parties as a source of the communication session;
extracting information from a message sent from the source to a destination party to form a communication summary, the communication summary including an indication of the phase of a service transaction;
formatting the communication summary; and
appending the communication summary in an independent log.

2. The method of claim 1, wherein appending comprises maintaining an auditable record.

3. The method of claim 1, wherein formatting comprises adding a timestamp to the communication summary.

4. The method of claim 1, wherein formatting comprises at least one of a proposed term, a changed term, and an agreed to term.

5. The method of claim 4, wherein formatting further comprises the identity of the party responsible for at least one of the proposed term, the changed term, and the agreed to term.

6. The method of claim 1, wherein formatting comprises identifying an e-service transaction contemplated by the first of the parties and the destination party.

7. The method of claim 6, wherein formatting further comprises at least an e-service transaction and a proposed term.

8. The method of claim 1, wherein formatting comprises identifying a stage of an e-service transaction contemplated by the first of the parties and the destination party.

9. The method of claim 8, wherein formatting further comprises identifying a stage of an e-service transaction selected from the group consisting of formation and execution.

10. The method of claim 1, wherein recognizing is performed independently of the source party and the destination party.

11. The method of claim 1, further comprising:
forwarding a copy of the communication summary.

12. The method of claim 11, wherein forwarding comprises communicating with a data storage device.

13. The method of claim 11, wherein forwarding comprises communicating with at least one the source party and the destination party.

14. A computer-readable medium having a program for establishing an independent record of communications between parties to an e-service transaction, the program comprising:
logic configured to recognize when a first party and a second party have established a communication session, the communication session for negotiating the terms of the e-service transaction;
logic configured to generate a communication summary responsive to the logic configured to realize and the content transferred between the first party and the second party; and
logic configured to associate a plurality of communication summaries.

15. The computer-readable medium of claim 14, wherein the logic configured to recognize is operable on a communication device coupled to a network.

16. The computer-readable medium of claim 14, wherein the logic configured to recognize is responsive to at least one the first and the second parties.

17. The computer-readable medium of claim 14, wherein the logic configured to generate comprises a record formatter.

18. The computer-readable medium of claim 14, wherein the logic configured to generate comprises an identity discriminator.

19. The computer-readable medium of claim 14, wherein the logic configured to generate comprises a communication discriminator.

20. The computer-readable medium of claim 14, wherein the logic configured to associate appends the communication summary to an auditable record.

21. An e-service system, comprising:
means for monitoring communications between proposed parties to an e-service transaction, the communications operative on a network;
means for generating a communication summary responsive to the means for monitoring; and
means for integrating the communication summary in a log.

22. The system of claim 21, wherein the means for monitoring is responsive to at least one of the proposed parties to the e-service transaction.

23. The system of claim 21, wherein the means for monitoring comprises a contract manager coupled to the network.

24. The system of claim 21, wherein the means for monitoring comprises an e-service transaction identifier.

25. The system of claim 21, wherein the means for generating comprises an auditable record engine.

26. The system of claim 21, wherein the means for integrating comprises a record formatter.

27. The system of claim 21, further comprising:
means for forwarding the communication summary.

28. A contract manager, comprising:
a network interface configured to monitor communications between an e-customer and an e-vendor coupled to a network; and
an auditable record engine, the auditable record engine comprising:
an identity discriminator configured to receive the communications and identify the e-customer and the e-vendor;
a communication discriminator configured to receive the communications, extract information indicative of a stage of a e-service transaction; and
a record formatter configured to receive information from the identity discriminator and the communication discriminator, the record formatter further configured to generate an independent summary of the communication session.

29. The contract manager of claim 28, wherein the identity discriminator is configured to identity which of the e-customer and the e-vendor initiated a communication session between the e-customer and the e-vendor.

30. The contract manager of claim 28, wherein the communication discriminator extracts information indicative of a stage selected from at least formation and execution.

31. The contract manager of claim 28, wherein the communication discriminator is further configured to extract at least one of a proposed term, a modified term, and an agreed term.

32. The contract manager of claim 28, wherein the record formatter forwards the independent summary of the communication session to at least one of the e-vendor and the e-customer.

33. The contract manager of claim 28, wherein the record formatter appends the independent summary of the communication session to an auditable record.
